(19) United States
(12) Patent Application Publication
(10) Pub. No.: US 2019/0277615 A1
(43) Pub. Date: Sep. 12, 2019

(54) MEASUREMENT APPARATUS

(71) Applicant: Mitutoyo Corporation, Kawasaki (JP)

(72) Inventors: Shingo Kiyotani, Utsunomiya (JP); Kanae Kobayashi, Utsunomiya (JP); Tomohiro Usui, Utsunomiya (JP); Tatsuya Terauchi, Utsunomiya (JP)

(21) Appl. No.: 16/294,364

(22) Filed: Mar. 6, 2019

(30) Foreign Application Priority Data
Mar. 8, 2018 (JP) 2018-041634

(51) Int. Cl. G01B 5/012

(52) U.S. Cl. CPC G01B 5/012

(57) ABSTRACT

A measurement apparatus includes a probe that measures a workpiece; a moving body that moves upon receiving a driving force from a drive part while supporting the probe; a position detection part that detects a position of a moving body when the probe measures the workpiece while the moving body is moving; a displacement acquisition part that acquires an amount of displacement of the probe when the moving body moves on the basis of a detection result of a detection sensor; and a measurement value acquisition part that acquires a measurement value of the workpiece on the basis of the position of the moving body detected by the position detection part and the amount of displacement of the probe acquired by the displacement acquisition part.

### CROSS-REFERENCE TO RELATED APPLICATIONS

The present application claims priority to Japanese Patent Application number 2018-041634, filed on Mar. 8, 2018. The contents of this application are incorporated herein by reference in their entirety.

### BACKGROUND

This invention relates to a measurement apparatus for measuring an object to be measured with a probe.

As a measurement apparatus, a coordinate measuring machine (CMM) that measures coordinates and the like of an object to be measured, for example, by moving a probe in the directions of three orthogonal axes has been used (refer to Japanese Unexamined Patent Publication No. 2012-002715). In this measurement apparatus, the probe is supported by a moving body which moves in the directions of three orthogonal axes. Also, the measurement apparatus measures the coordinates and the like of the object to be measured by detecting a position of the moving body when the probe contacts the object to be measured.

The above-mentioned moving body, which moves upon receiving a driving force, may deform when it moves. For example, when the moving body moves to perform a scanning measurement with the probe, an elastic deformation of the moving body may occur due to an acceleration of the moving body caused by receiving the driving force. If the moving body is deformed, a position of the probe supported by the moving body may change, thereby causing an error in a measurement value (such as coordinates of the object to be measured.)

### SUMMARY

This invention focuses on this point, and an object of the present invention is to obtain a measurement value with high accuracy even if the probe is displaced due to deformation of the moving body.

A measurement apparatus according to the first aspect of the present invention includes: a probe that measures an object to be measured; a moving body that moves upon receiving a driving force from a driving source while supporting the probe; a position detection part that detects a position of a moving body when the probe measures the object to be measured while the moving body is moving; a displacement acquisition part that acquires an amount of displacement of the probe due to deformation of the moving body while the moving body is moving, on the basis of a detection result of a detection sensor provided in the moving body; and a measurement value acquisition part that acquires a measurement value of the object to be measured on the basis of the position of the moving body detected by the position detection part and the amount of displacement of the probe acquired by the displacement acquisition part.

### BRIEF DESCRIPTION OF THE DRAWINGS

FIG. 1 is a block diagram showing a schematic configuration of a coordinate measuring machine (CMM) 1 according to the first embodiment of the present invention.

FIG. 2 is a perspective view for illustrating an example of a configuration of a measurement machine body 2.

FIGS. 3A and 3B are each a schematic diagram for illustrating a displacement state of a probe 40 due to deformation of a moving body 21.

FIG. 4 is a schematic diagram for illustrating an acceleration sensor 50A provided in the moving body 21.

FIG. 5 is a schematic diagram for illustrating Variation 1.

FIG. 6 is a schematic diagram for illustrating Variation 2.

FIG. 7 is a block diagram showing a variation example of the configuration of the CMM 1.

### DETAILED DESCRIPTION

Hereinafter, the present invention will be described through exemplary embodiments of the present invention, but the following exemplary embodiments do not limit the invention according to the claims, and not all of the combinations of features described in the exemplary embodiments are necessarily essential to the solution means of the invention.

<Configuration of a Coordinate Measuring Machine (CMM)>

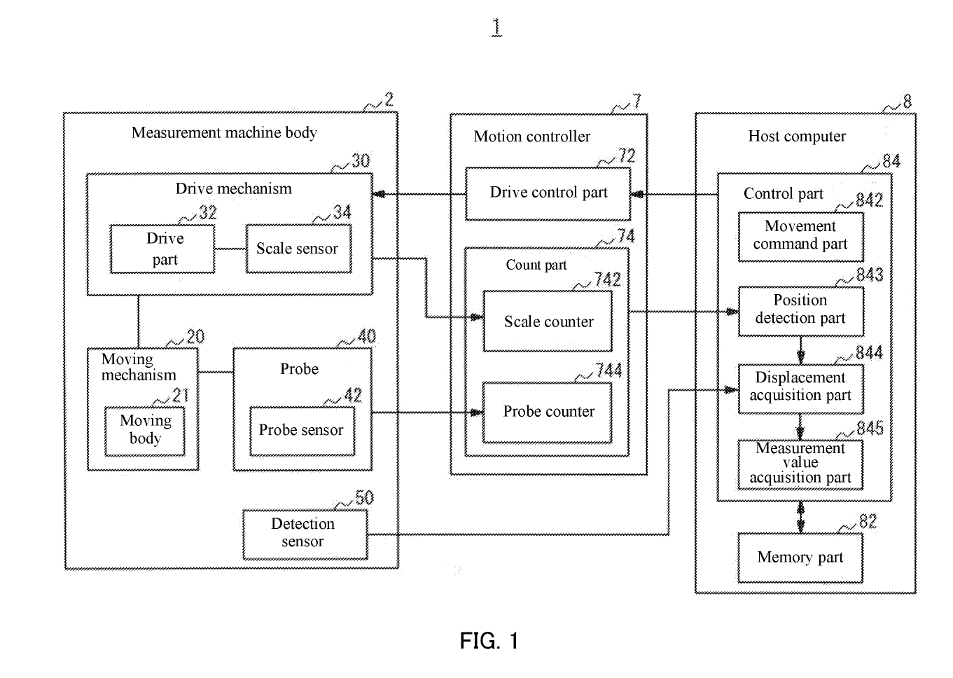

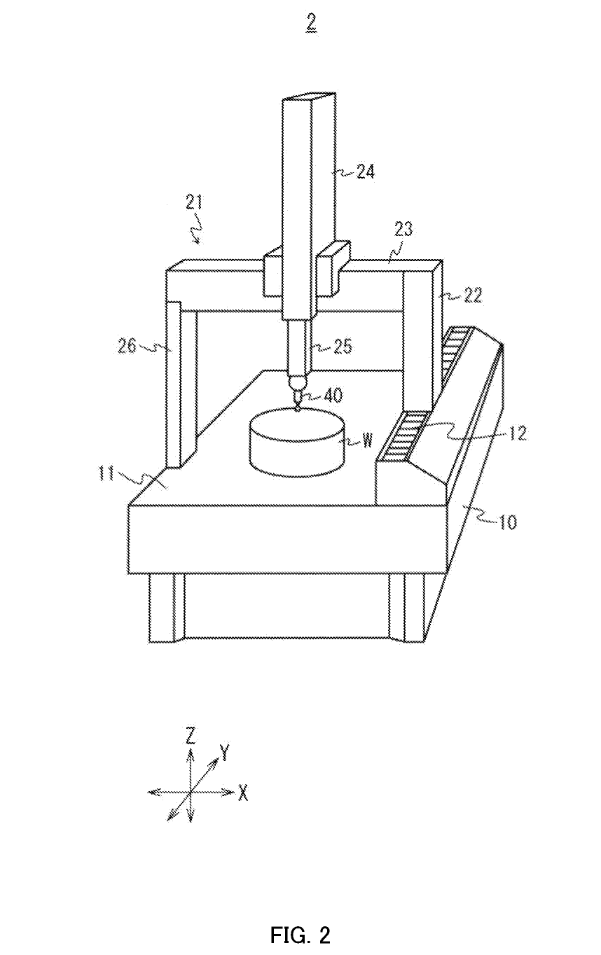

A configuration of a coordinate measuring machine (CMM) according to the first embodiment of the present invention will be described by referring to FIGS. 1 and 2.

FIG. 1 is a block diagram showing a schematic configuration of the coordinate measuring machine (CMM) 1 according to the first embodiment of the present invention. FIG. 2 is a perspective view for illustrating an example of a configuration of a measurement machine body 2. The CMM 1 includes, as shown in FIG. 1, the measurement machine body 2, a motion controller 7, and a host computer 8.

The measurement machine body 2 includes, as shown in FIGS. 1 and 2, a base 10, a moving mechanism 20, a drive mechanism 30, a probe 40, and a detection sensor 50. The measurement machine body 2 measures a workpiece W placed on the base 10, as shown in FIG. 2, with the probe 40 which is moved by the moving mechanism 20.

The base 10 is formed with a rectangular plate shape, as shown in FIG. 2. The base 10 has a placement surface 11 on which the workpiece W which is the object to be measured is placed. On the first end of the base 10 in an X-axis direction, a guide part 12 is provided along a Y-axis direction. The guide part 12 guides movement of the moving mechanism 20 (specifically, a column 22 of the moving mechanism 20) along the Y-axis direction.

The moving mechanism 20 is a mechanism that moves the probe 40 within a measurement space while supporting the probe 40. The moving mechanism 20 includes a moving body 21 (FIG. 1) that moves in the directions of three orthogonal axes (an X axis, a Y axis, and a Z axis) within the measurement space. The moving body 21 is provided in a gate shape so as to straddle over the base 10, as shown in FIG. 2. The moving body 21 contains a plurality of moving members for moving in the directions of the three orthogonal axes. Specifically, the moving body 21 contains the column 22, a beam 23, a slider 24, a ram 25, and a post 26.

The column 22 is provided to stand on the guide part 12. The column 22 is movable along the Y-axis direction on the guide part 12 by a drive part 32 (FIG. 1) of the drive mechanism 30. When measurement starts, the moving body 21 is accelerated by the drive part 32 which drives the column 22.

The beam 23 is provided to extend in the X-axis direction. The first end of the beam 23 in a longitudinal direction is supported by the column 22, and the second end of the beam 23 in the longitudinal direction is supported by the post 26. The beam 23 moves together with the column 22 along the Y-axis direction.

The slider 24 is movably supported by the beam 23 and is formed in a tubular shape along a Z-axis direction. The slider 24 is movable along the X-axis direction on the beam 23 by the drive part 32.

The ram 25 is inserted inside of the slider 24 and moves together with the slider 24 in the X-axis direction. Also, the ram 25 is movable in the slider 24 along the Z-axis direction by the drive part 32. In this embodiment, the ram 25 corresponds to a rod-shaped supporting member which supports the probe 40. The ram 25 supports the probe 40 at the first end of the ram 25 in an axial direction. The ram 25 is movable together with the slider 24 along the X-axis direction while the slider 24 holds the second end of the ram 25 in the axial direction. Also, the ram 25 is movable together with the beam 23 along the Y-axis direction.

The drive mechanism 30 moves the probe 40 in the X-axis, Y-axis, and Z-axis directions by driving the moving body 21. The drive mechanism 30 has, as shown in FIG. 1, the drive part 32 and a scale sensor 34.

The drive part 32 has a driving source, for example, a motor and the like, and moves the column 22, the beam 23, the slider 24 and the ram 25 of the moving body 21. It should be noted that the drive part 32 includes an X-axis drive part, a Y-axis drive part, and a Z-axis drive part and can move the probe 40 in the X-axis, Y-axis, and Z-axis directions separately. Receiving a driving force from the drive part 32, the moving body 21 moves and accelerates.

The scale sensor 34 is a sensor that detects an amount of movement in the X-axis, Y-axis, and Z-axis directions (a position of the moving mechanism 20 after being moved) of the moving mechanism 20 driven by the drive mechanism 30. The scale sensor 34 is, for example, a linear encoder, and includes (i) a scale having graduations and serving as a ruler, and (ii) a detector that acquires position information from the graduations.

The probe 40 is a probe for measuring the workpiece W placed on the base 10. For example, the probe 40 performs a scanning measurement of a 3D position of the workpiece W by moving while contacting the workpiece W. The probe 40 has a probe sensor 42 that can detect, for example, contact with the workpiece W.

The detection sensor 50 is a sensor that detects an amount of deformation of the moving body 21 (for example, an amount of deformation of the ram 25 that supports the probe 40). The detection sensor 50, as will be described in detail below, detects the amount of deformation of the moving body 21 that would occur when the moving body 21 accelerates upon receiving the driving force from the drive part 32 at the start of a measurement. The detection sensor 50 is provided in the moving body 21, for example.

The motion controller 7 performs drive control of the measurement machine body 2. The motion controller 7 has, as shown in FIG. 1, a drive control part 72 and a count part 74. Receiving a command from the host computer 8, the drive control part 72 performs drive control of the drive part 32 of the drive mechanism 30.

The count part 74 counts pulse signals output from the scale sensor 34 and the probe sensor 42. The count part 74 has a scale counter 742 and a probe counter 744.

The scale counter 742 counts the pulse signals output from the scale sensor 34 and measures a position of the moving body 21 in the X-axis, Y-axis, and Z-axis directions (also referred to as a scale position hereinafter). The scale counter 742 outputs the measured scale position to the host computer 8.

The probe counter 744 counts the pulse signals output from the probe sensor 42 and measures a position of the probe 40 in the X-axis, Y-axis, and Z-axis directions (also referred to as a probe position hereinafter). The probe counter 744 outputs the measured probe position to the host computer 8.

The host computer 8 is a processing apparatus that gives commands to the motion controller 7 and performs calculations such as shape analyses of the workpiece W. The host computer 8 has, for example, a memory part 82 and a control part 84, as shown in FIG. 1.

The memory part 82 stores programs to be executed by the control part 84 and various types of data. The control part 84 controls operation of the measurement machine body 2 by executing a program stored in the memory part 82. The control part 84 functions as a movement command part 842, a position detection part 843, a displacement acquisition part 844, and a measurement value acquisition part 845.

The movement command part 842 gives a command to the drive control part 72 and moves the moving body 21 (e.g., the column 22, the beam 23, the slider 24, and the ram 25) of the moving mechanism 20 along the X-axis, Y-axis, and Z-axis directions.

The position detection part 843 detects a position after the movement (that is, the scale position) of the moving body 21 in the X-axis, Y-axis, and Z-axis directions. For example, the position detection part 843 detects the scale position from a measurement result of the scale counter 742.

The displacement acquisition part 844 acquires an amount of displacement of the probe 40 due to deformation of the moving body 21 when the moving body 21 moves. Receiving the driving force from the drive part 32, the moving body 21 moves and accelerates, and the moving body 21 may elastically deform because of the acceleration of the moving body 21. Due to the elastic deformation of the moving body 21, the probe 40 (specifically, a tip position 40a that contacts the workpiece W of the probe 40) would be displaced. In view of this, the displacement acquisition part 844 acquires the amount of displacement of the probe 40 due to the deformation of the moving body 21 when the moving body 21 moves and accelerates as it receives the driving force. For example, the displacement acquisition part 844 acquires an amount of displacement of the probe 40 due to deformation (specifically, deflection) of the ram 25 when the ram 25 of the moving body 21 moves and accelerates.

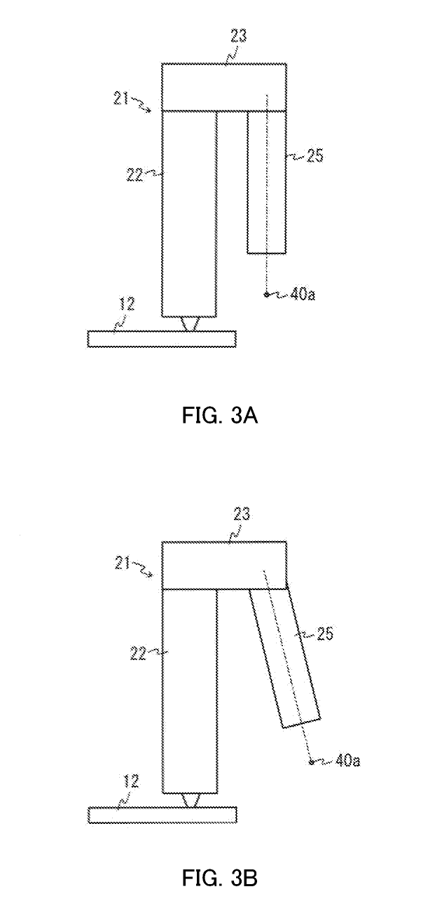

FIGS. 3A and 3B are each a schematic diagram for illustrating a displacement of the tip position 40a due to the deformation of the moving body 21. In FIGS. 3A and 3B, as a matter of convenience, only the tip position 40a of the probe 40 is shown and other portions of the probe 40 are omitted. Also, FIG. 3A shows the moving body 21 before deformation, and FIG. 3B shows the moving body 21 after deformation. Here, when the moving body 21 accelerates upon receiving the driving force from the drive part 32, the ram 25 of the moving body 21 is elastically deformed (deflected) from a state shown in FIG. 3A to a state shown in FIG. 3B. An amount of deflection of the ram 25 increases in proportion to the acceleration of the moving body 21. A position of the tip position 40a of the probe 40 supported with the ram 25 would also be displaced, in accordance with the deflection of the ram 25, from the position shown in FIG. 3A to the position shown in FIG. 3B. When the tip position 40a of the probe 40 is displaced in such a manner, errors in measurement values of the workpiece W may occur. It should be noted that the explanation of the displacement of the tip position 40a of the probe 40 due to the deformation of the ram 25 has been provided above, but the embodiment is not limited to this. The tip position 40a of the probe 40 may be displaced due to deformation of the column 22, the beam 23, or the slider 24.

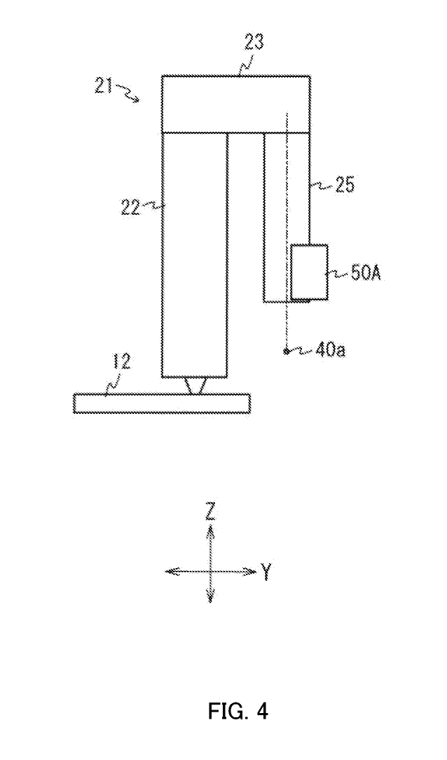

The displacement acquisition part 844 acquires the amount of displacement of the probe 40 on the basis of a detection result of the detection sensor 50 provided in the moving body 21. As the detection sensor 50, an acceleration sensor 50A is provided in the moving body 21, as shown in FIG. 4.

FIG. 4 is a schematic diagram for illustrating the acceleration sensor 50A provided in the moving body 21. The acceleration sensor 50A is provided on the ram 25 which is a supporting member that supports the probe 40. Specifically, the acceleration sensor 50A is provided at a tip side of the ram 25. The acceleration sensor 50A detects the acceleration of the ram 25 when the ram 25 deforms when the moving body 21 moves. The acceleration sensor 50A acquires the acceleration of the ram 25 in each axial direction when the moving body 21 moves in the directions of the three orthogonal axes (the X axis, the Y axis, and the Z axis). In this way, the amount of deformation of the ram 25 in each axial direction can be accurately obtained.

The displacement acquisition part 844 acquires the amount of displacement of the probe 40 due to the deformation of the moving body 21 on the basis of the acceleration detected by the acceleration sensor 50A. For example, the displacement acquisition part 844 acquires the amount of displacement of the probe 40 due to the deformation of the moving body 21 by integrating the acceleration detected by the acceleration sensor 50A. Specifically, the displacement acquisition part 844 acquires the amount of displacement of the tip position 40a of the probe 40 by obtaining the amount of deflection of the ram 25 by second-order integrating the acceleration detected by the acceleration sensor 50A. Also, since the amount of deflection of the ram 25 is obtained by using measured data detected by the acceleration sensor 50A, the accuracy is improved.

The displacement acquisition part 844 may acquire the amount of displacement of the probe 40 due to the deformation of the moving body 21 on the basis of (i) correspondence information indicating a correspondence relationship between the acceleration of the ram 25 and the amount of displacement of the probe 40 and (ii) the acceleration detected by the acceleration sensor 50A. The above-mentioned correspondence information is characteristic model (transfer function) information of the moving body 21 which is a structure. The correspondence information is stored in the memory part 82, for example (FIG. 1). By referencing the characteristic model information, the displacement acquisition part 844 can acquire the amount of displacement of the probe 40 corresponding to the acceleration detected by the acceleration sensor 50A. In this case, it is easier to acquire the amount of displacement of the probe 40 because there is no need to calculate an amount of deflection of the moving body 21 by second-order integrating the acceleration.

It should be noted that, in the above description, the acceleration sensor 50A was provided on the ram 25, but the embodiment is not limited to this. For example, the acceleration sensor 50A may be provided on each of the column 22, the beam 23, and the ram 25. In this case, a plurality of the acceleration sensors 50A appropriately detect the respective amounts of deformation in each axial direction of the column 22, the beam 23, and the ram 25. The displacement acquisition part 844 acquires, with high accuracy, the amount of deformation of the probe 40 due to the deformations of the column 22, the beam 23, and the ram 25 on the basis of the respective amounts of deformation of the column 22, the beam 23, and the ram 25. The displacement acquisition part 844 may adjust the amounts of deformation of the column 22, the beam 23, and the ram 25 by taking a moving direction of the moving body 21 into consideration.

The measurement value acquisition part 845 acquires a measurement value of the workpiece W on the basis of the position of the moving body 21 (scale position) and the position of the probe 40. If the probe 40 is displaced due to the deformation of the moving body 21, the measurement value acquisition part 845 acquires the measurement value taking into consideration the amount of displacement of the probe 40. That is, the measurement value acquisition part 845 acquires the measurement value of the workpiece W on the basis of the position of the moving body 21 detected by the position detection part 843 and the amount of displacement of the probe 40 detected by the displacement acquisition part 844. Specifically, the measurement value acquisition part 845 acquires the measurement value of the workpiece W by correcting the position of the moving body 21 detected by the position detection part 843 by using the amount of displacement of the probe 40 which the displacement acquisition part 844 acquired. In this way, even if the moving body 21 deforms when measuring the workpiece W with the probe 40, the occurrence of a measurement error can be suppressed.

It should be noted that, in order to reduce the measurement error, increasing rigidity of the moving body 21 may be conceived of as a measure to suppress the deformation of the moving body 21 when it accelerates. If the rigidity of the moving body 21 is to be increased, upsizing of the moving body 21 would be inevitable, and that would eventually result in a weight increase of the moving body 21. Whereas, if the measurement value of the workpiece W is acquired while taking into consideration the amount of displacement of the probe 40 as in the present embodiment described above, the weight of the moving body 21 would not increase as there is no need to increase the rigidity of the moving body 21.

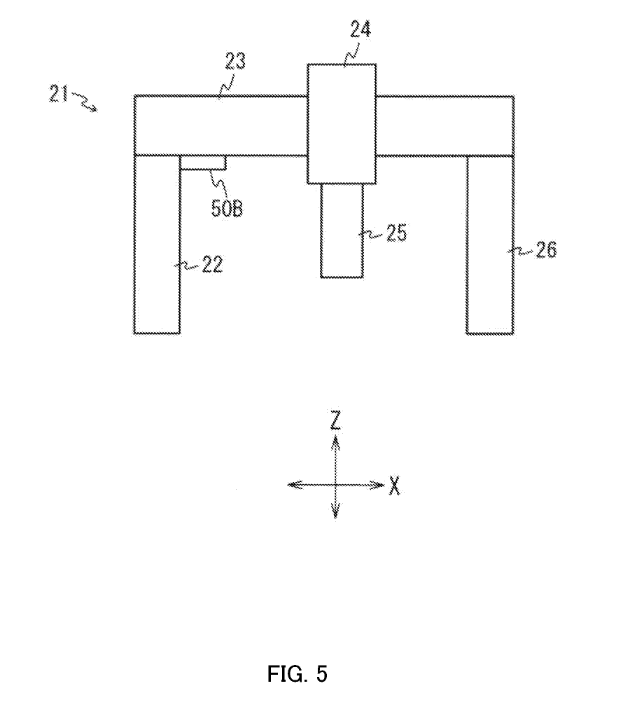

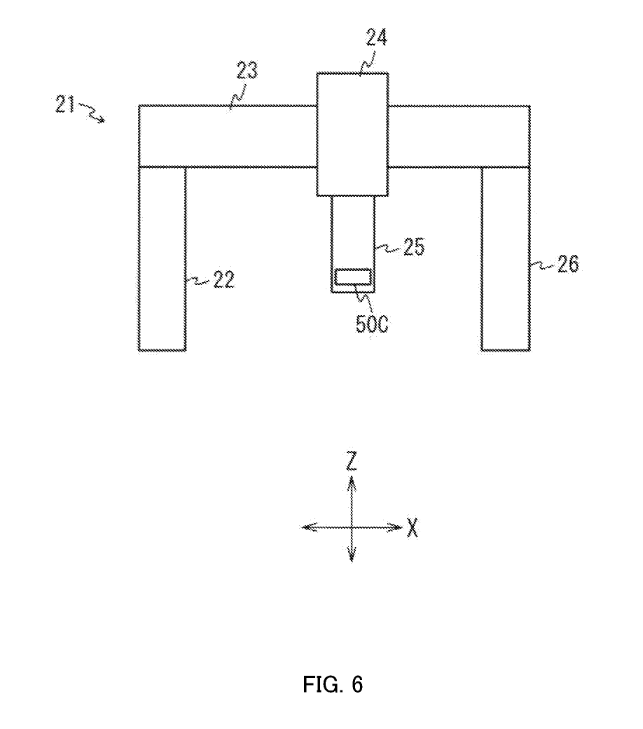

In the above description, the detection sensor 50 served as the acceleration sensor 50A shown in FIG. 4, but the embodiment is not limited to this. For example, the detection sensor 50 may be a deformation amount detection sensor 50B shown in FIG. 5 or a position detection sensor 50C shown in FIG. 6.

(Variation 1)

FIG. 5 is a schematic diagram for illustrating Variation 1. It should be noted that, as a matter of convenience, the probe 40 is omitted in FIG. 5. In Variation 1, the deformation amount detection sensor 50B is provided in place of the acceleration sensor 50A. The deformation amount detection sensor 50B is, for example, a strain gauge sensor or a displacement sensor and detects the amount of deformation of the moving body 21 when it moves.

The deformation amount detection sensor 50B is provided on the column 22 of the moving body 21 (specifically, around a connecting portion of the column 22 and the beam 23) as shown in FIG. 5. When the moving body 21 starts to move, the column 22 accelerates upon receiving the driving force from the drive part 32 provided in the guide part 12 (FIG. 2). For this reason, the deformation amount detection sensor 50B can be considered to be provided near the drive part 32 that accelerates the moving body 21. In this way, the amount of deformation of the moving body 21 that would occur when the moving body 21 accelerates upon receiving the driving force from the drive part 32 can be accurately acquired.

The displacement acquisition part 844 (FIG. 1) acquires an amount of displacement of the probe 40 due to the deformation of the moving body 21 on the basis of the amount of deformation detected by the deformation amount detection sensor 50B. The displacement acquisition part 844 acquires the amount of displacement of the probe 40 due to the deformation of the moving body 21 on the basis of (i) correspondence information indicating a correspondence relationship between the amount of deformation of the moving body 21 and the amount of displacement of the probe 40 and (ii) the amount of deformation detected by the deformation amount detection sensor 50B. The above-mentioned correspondence information is characteristic model (transfer function) information of the moving body 21 which is a structure. The correspondence information is stored in the memory part 82, for example (FIG. 1). By referencing the characteristic model information, the displacement acquisition part 844 can acquire the amount of displacement of the probe 40 corresponding to the amount of deformation detected by the deformation amount detection sensor 50B.

The measurement value acquisition part 845 acquires a measurement value of the workpiece W by correcting the position of the moving body 21 detected by the position detection part 843 with the amount of displacement of the probe 40 acquired by the displacement acquisition part 844. In this way, even if the moving body 21 deforms when measuring the workpiece W with the probe 40, the occurrence of a measurement error can be suppressed.

(Variation 2)

FIG. 6 is a schematic diagram for illustrating Variation 2. It should be noted that, as a matter of convenience, the probe 40 is omitted in FIG. 6. In Variation 2, the position detection sensor 50C is provided in place of the acceleration sensor 50A. The position detection sensor 50C is provided on the ram 25 of the moving body 21 and detects a position of the ram 25.

The position detection sensor 50C is provided on the ram 25 of the moving body 21 as shown in FIG. 6. Specifically, the position detection sensor 50C is provided at the tip side (the side that supports the probe 40) of the ram 25.

The displacement acquisition part 844 (FIG. 1) acquires the amount of displacement of the probe 40 on the basis of a detection result of the position detection sensor 50C. For example, when the ram 25 is deformed, the displacement acquisition part 844 estimates the amount of displacement of the probe 40 by detecting a position of the deformed ram 25 (for example, a displacement from a reference position of the ram before the deformation). By using the amount of displacement of the probe 40 acquired in this manner, the occurrence of a measurement error can be suppressed even if the moving body 21 deforms when measuring the workpiece W with the probe 40.

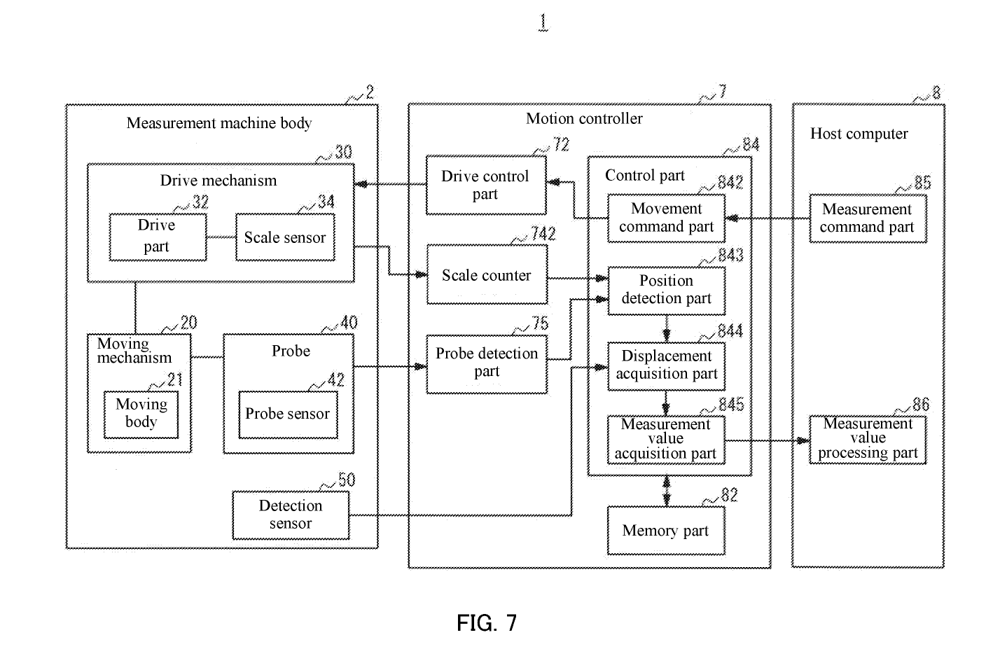

In the above description, the host computer 8 had the control part 84 that functions as the position detection part 843 and the like, but the embodiment is not limited to this. For example, as shown in FIG. 7, the control part 84 may be provided in the motion controller 7. FIG. 7 is a block diagram showing a variation example of the configuration of the CMM 1. In the CMM 1 shown in FIG. 7, the motion controller 7 has the memory part 82 and the control part 84. Whereas, the host computer 8 has a measurement command part 85 that gives a command to the movement command part 842 and a measurement value processing part 86 that processes the measurement value acquired by the measurement value acquisition part 845. Also, in place of the probe counter 744 (refer to FIG. 1), a probe detection part 75 that detects the position of the probe 40 without using any counter is provided in FIG. 7.

### Effects of the Present Embodiment

The above-mentioned CMM 1 acquires the amount of displacement of the probe 40 due to the deformation (for example, the deflection of the ram when the ram 25 moves and accelerates) of the moving body 21 when the moving body 21 moves on the basis of the detection result of the detection sensor 50 (for example, the acceleration sensor 50A provided on the ram 25) provided in the moving body 21. Then, the CMM 1 acquires the measurement value of the workpiece W on the basis of the detected position of the moving body 21 (scale position) and the acquired amount of displacement of the probe 40. In this way, the amount of displacement of the probe 40 due to the deformation of the moving body 21 can be obtained with high accuracy on the basis of measured data detected by the detection sensor 50. Also, the occurrence of a measurement error can be suppressed because the measurement value of the workpiece W is corrected by reflecting the obtained displacement amount of the probe 40. In particular, by using the measured data detected by the detection sensor 50, the measurement value can be acquired with high accuracy even if the probe 40 is displaced due to the deformation of the moving body 21.

In the above description, the probe 40 was a contact type probe that contacts the workpiece W, but the embodiment is not limited to this. For example, the probe 40 may be a non-contact type probe such as a laser device, a camera, or the like.

Also, in the above description, the moving mechanism 20 moved the probe 40 in each direction on the three orthogonal axes, but the embodiment is not limited to this. For example, the moving mechanism 20 may move the probe 40 in one or two axial directions of any of the X axis, Y axis, and Z axis.

Also, in the above description, the moving body 21 had the gate shape structure as shown in FIG. 2, but the embodiment is not limited to this. The moving body 21 may have other structures as long as it can move in a state of supporting the probe 40.

The present invention is explained on the basis of the exemplary embodiments. The technical scope of the present invention is not limited to the scope explained in the above embodiments and it is possible to make various changes and modifications within the scope of the invention. For example, the specific embodiments of the distribution and integration of the apparatus are not limited to the above embodiments, all or part thereof, can be configured with any unit which is functionally or physically dispersed or integrated. Further, new exemplary embodiments generated by arbitrary combinations of them are included in the exemplary embodiments of the present invention. Further, effects of the new exemplary embodiments brought by the combinations also have the effects of the original exemplary embodiments.

What is claimed is:

1. A measurement apparatus comprising:
a probe that measures an object to be measured;
a moving body that moves upon receiving a driving force from a driving source while supporting the probe;
a position detection part that detects a position of a moving body when the probe measures the object to be measured while the moving body is moving;
a displacement acquisition part that acquires an amount of displacement of the probe due to deformation of the moving body while the moving body is moving, on the basis of a detection result of a detection sensor provided in the moving body; and
a measurement value acquisition part that acquires a measurement value of the object to be measured on the basis of the position of the moving body detected by the position detection part and the amount of displacement of the probe acquired by the displacement acquisition part.

2. The measurement apparatus according to claim 1, wherein the moving body moves and accelerates upon receiving the driving force, and
the displacement acquisition part acquires the amount of displacement of the probe due to the deformation of the moving body when the moving body moves and accelerates.

3. The measurement apparatus according to claim 2, wherein the moving body has a rod-shaped supporting member that supports the probe, and
the displacement acquisition part acquires an amount of displacement of the probe due to deformation of the supporting member when the supporting member moves and accelerates.

4. The measurement apparatus according to claim 3, wherein the supporting member supports the probe at a first end thereof in an axial direction,
upon receiving the driving force, the moving body causes the supporting member to move and accelerate while holding a second end of the supporting member in the axial direction, and
the displacement acquisition part acquires an amount of displacement of the probe due to deflection of the supporting member when the supporting member moves and accelerates.

5. The measurement apparatus according to claim 1, wherein the measurement value acquisition part acquires a measurement value of the object to be measured by correcting the position of the moving body detected by the position detection part by using the amount of displacement of the probe which the displacement acquisition part acquired.

6. The measurement apparatus according to claim 1, further comprising
an acceleration sensor, serving as the detection sensor, that detects acceleration of the supporting member when the moving body moves and is provided on the supporting member which supports the probe, wherein the displacement acquisition part acquires the amount of displacement of the probe due to the deformation of the moving body on the basis of the acceleration detected by the acceleration sensor.

7. The measurement apparatus according to claim 6, wherein the displacement acquisition part acquires the amount of displacement of the probe due to the deformation of the moving body by integrating the acceleration detected by the acceleration sensor.

8. The measurement apparatus according to claim 6, wherein the displacement acquisition part acquires the amount of displacement of the probe due to the deformation of the moving body on the basis of (i) correspondence information indicating a correspondence relationship between the acceleration of the supporting member and the amount of displacement of the probe and (ii) the acceleration detected by the acceleration sensor.

9. The measurement apparatus according to claim 6, wherein the moving body contains a plurality of moving members that move in directions perpendicular to each other, and
the acceleration sensor is provided on the supporting member of one of the plurality of moving members that supports the probe.

10. The measurement apparatus according to claim 6, wherein the moving body contains a plurality of moving members that move in directions perpendicular to each other,
the acceleration sensor is provided on each of the plurality of moving members, and
the displacement acquisition part acquires the amount of displacement of the probe due to deformation of each of the moving members.

11. The measurement apparatus according to claim 1, further comprising
a deformation amount detection sensor, serving as the detection sensor, that detects an amount of deformation of the moving body when the moving body moves, wherein the displacement acquisition part acquires the amount of displacement of the probe due to the deformation of the moving body on the basis of the amount of deformation detected by the deformation amount detection sensor.

12. The measurement apparatus according to claim 11, wherein the moving body contains a plurality of moving members for moving in directions of three orthogonal axes, wherein the deformation amount detection sensor is provided on a moving member on the driving source side among the plurality of moving members.

13. The measurement apparatus according to claim 11, wherein the displacement acquisition part acquires the amount of displacement of the probe due to the deformation of the moving body on the basis of (i) correspondence information indicating a correspondence relationship between the amount of deformation of the moving body and the amount of displacement of the probe and (ii) the amount of deformation detected by the deformation amount detection sensor.

14. The measurement apparatus according to claim 1, further comprising
a position detection sensor, serving as the detection sensor, that detects a position of the supporting member and is provided on the supporting member which supports the probe, wherein the displacement acquisition part acquires the amount of displacement of the probe on the basis of a detection result of the position detection sensor.
